(19) United States
(12) Patent Application Publication
(10) Pub. No.: US 2005/0132265 A1
(43) Pub. Date: Jun. 16, 2005

(54) Computer-implemented methods and systems for control of video event and phone event

(76) Inventors: Gregory Pulier, Los Angeles, CA (US); John David Busfield, Valencia, CA (US); Brett Charles Law, Los Alamitos, CA (US)

Correspondence Address: STEPHEN D. SCANLON, JONES DAY, 901 LAKESIDE AVENUE, CLEVELAND, OH, 44114, US

(21) Appl. No.: 10/989,117

(22) Filed: Nov. 15, 2004

Related U.S. Application Data
(60) Provisional application No. 60/520,516, filed on Nov. 14, 2003.
(60) Provisional application No. 60/534,304, filed on Jan. 5, 2004.

(51) Int. Cl. G06F 15/00

(52) U.S. Cl. 715/500.1

(57) ABSTRACT

A computer-implemented system and method for controlling events related to presentations delivered over one or more networks. Video of a presentation is started and a phone call is made by the presenter. A live editor program pushes events as the presenter is speaking. These events are synchronized to the presentation. If synched in real time, the events are sent from live event servers directly to end viewers in real time. The end users are listening to the presentation on the conference call, and viewing the presentation on the web at the same time. The web page is updated in real time as events happen.

### CROSS-REFERENCE TO RELATED APPLICATIONS

This application claims priority to and the benefit of: U.S. Provisional Application Ser. No. 60/520,516, filed on Nov. 14, 2003, of which the entire disclosure (including any and all figures) is incorporated herein by reference; and U.S. Provisional Application Ser. No. 60/534,304, filed on Jan. 5, 2004, of which the entire disclosure (including any and all figures) is incorporated herein by reference

### TECHNICAL FIELD

This document relates generally to computer-implemented controlling of events and more particularly to controlling events associated with delivery of content over a network.

### BACKGROUND

Presentations provided over networks are useful in many contexts, such as in education and business settings. The ability to provide for remote presentations generates cost savings both for presenters and the audience since neither party has to travel for the presentations. Remote presentations can be provided over networks in real-time or in a batch mode, such as being available in an archive of presentations for selection by an audience member. However, difficulties arise when trying to control events associated with a presentation.

### SUMMARY

In accordance with the teachings provided herein, systems and methods for operation upon data processing devices are provided in order to overcome one or more of the aforementioned disadvantages or other disadvantages concerning handling control of video events and phone events.

As an example of a system and method, video for a presentation is started and a phone call is made by the presenter. A live editor program pushes events as the presenter is speaking. These events are synchronized to the presentation. When synched in real time, the events are sent from live event servers directly to end viewers in real time. The end users listen to the presentation on the conference call, and view the presentation on the web at the same time. The web page is updated in real time as events happen, and thus are synchronized to the phone conversation.

As another example, a system and method can be configured to control events related to presentations delivered over one or more networks. Video of a presentation is generated and a conference phone call is used to provide audio content for the presentation. A presentation program is used to push events as the presenter is speaking. The events are synchronized to the video of the presentation. When synched in real time, the events are sent from servers to end viewers. The end viewers listen to the presentation on the conference phone call and view the presentation through a web browser at about the same time. The web page is updated in about real time as events happen, thereby establishing synchronization to the conference phone communication.

As yet another example of a system and method, a single live control page can be configured to control both synchronized video presentation and a live phone presentation. Controls manipulated by a presenter by the single interface affect both the streamed video presentation as well as any phone presentations. For example, the single interface may push an event both to the end users listening on the phone as well as end users viewing the presentation via a video stream.

As will be appreciated, the systems and methods disclosed herein are capable of other and different embodiments, and capable of modifications in various respects. Accordingly, the drawings and description set forth herein are to be regarded as illustrative in nature and not restrictive.

### BRIEF DESCRIPTION OF THE DRAWINGS

FIG. 1 is a block diagram depicting software and computer components utilized in controlling phone and video events.

FIG. 2 is a block diagram depicting software and computer components utilized in authoring video pages and phone pages.

FIG. 3 is a graphical user interface depicting an example of an author entering preliminary information for a presentation project.

FIG. 4 is a graphical user interface depicting an example of an author selecting one or more templates for use in a presentation project.

FIG. 5 is a graphical user interface depicting an example of an interface wherein the author completes creation of a presentation project.

FIG. 6 is a graphical user interface depicting an example of providing e-mail options to end-user viewers.

FIG. 7 is a graphical user interface depicting an example of operating a live control panel to run a presentation.

FIG. 8 is a graphical user interface depicting an example of end-users viewing a presentation on a web page.

FIGS. 9 and 10 are graphical user interfaces depicting examples of a presenter having the option of customizing presentation pages.

### DETAILED DESCRIPTION

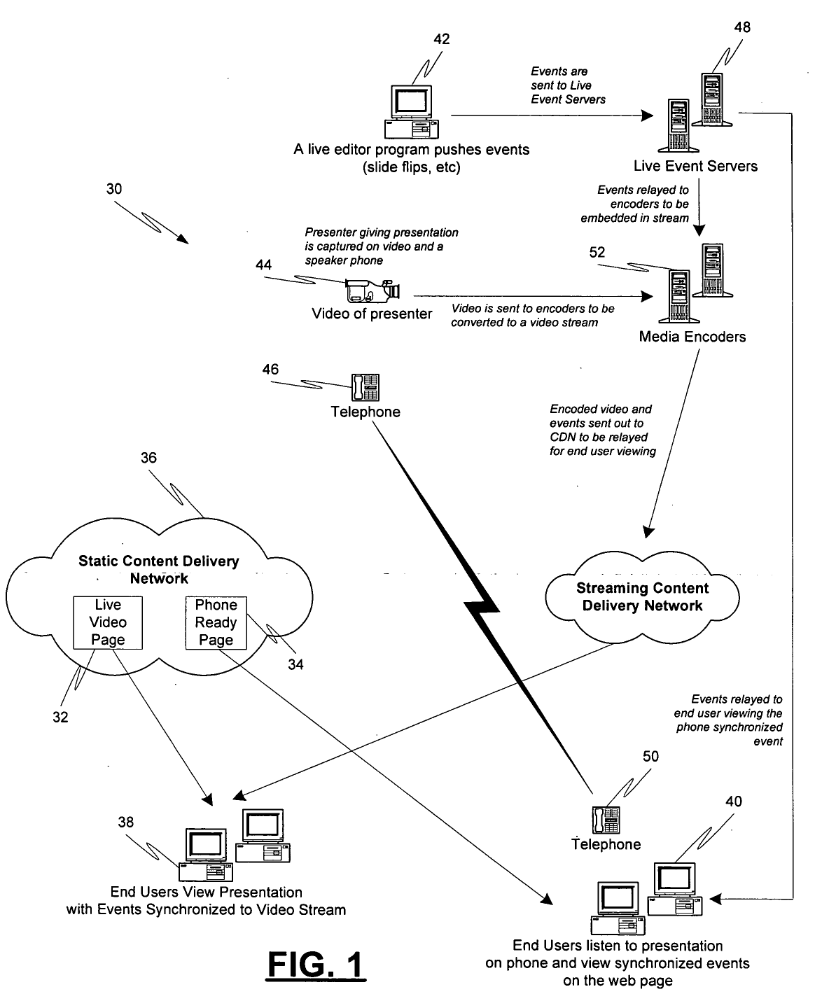

FIG. 1 shows a system 30 for handling simultaneous control of video events and phone events. An example of an operational scenario in reference to FIG. 1 is as follows.

Web pages (e.g., 32 and 34) are deployed to a content delivery network (CDN) 36 or other suitable location where end users 38 and 40 can view the pages. A web page 32 is selected to be used for a video synch event and a web page 34 is selected to be used for the phone event. The event is now prepped and ready to go.

When an event is to start, a user logs in to a live editor program 42 and starts the event. Video 44 is started and a phone call 46 is made by the presenter (e.g., person doing the speaking). The phone call 46 can make use of any conferencing system, or can even be a standard one-to-one conversation.

The live editor program 42 pushes events (e.g., presentation slide flips) as the presenter is speaking. These events are synchronized to the presentation in such ways as in real time, or synched to the video. When synched in real time, the events are sent from live event servers 48 directly to end viewers in real time. The end users (e.g., users 40) are listening to the presentation on the conference call 50 and viewing the presentation on the web at the same time. The web page is updated in real time as events happen, and thus are synchronized to the phone conversation.

When synched to the video, the video media encoders 52 inject the events into the video stream and are thus synchronized to the video at the point of injection. End viewers then receive these events (e.g., presentation slide flips) directly from the video stream and thus stay in synch with the video.

It should be understood that similar to the other processing flows described herein, the steps and the order of the steps described for this operational scenario may be altered, modified and/or augmented and still achieve the desired outcome.

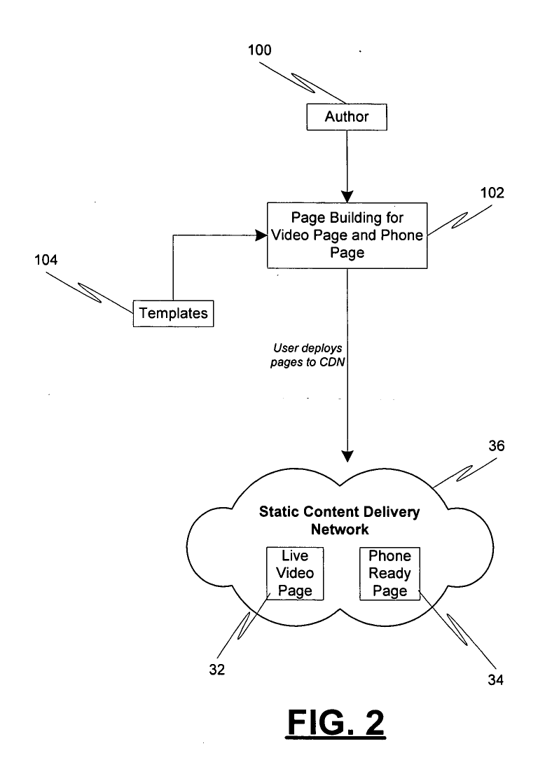

The live video page 32 and the phone ready page 34 that are deployed on the content delivery network 36 for access by end users 38 and 40 may be created in many different ways. For example, FIG. 2 shows a user 100 (e.g., an author) running a web page builder program 102 to select the templates 104 to be used for the presentation. A template is selected to be used for video synch event end users and a template is selected to be used for phone event end users. Web pages are formed from the templates and deployed on a network for access by end-users. It should be understood that templates are an optional way for creating the web pages.

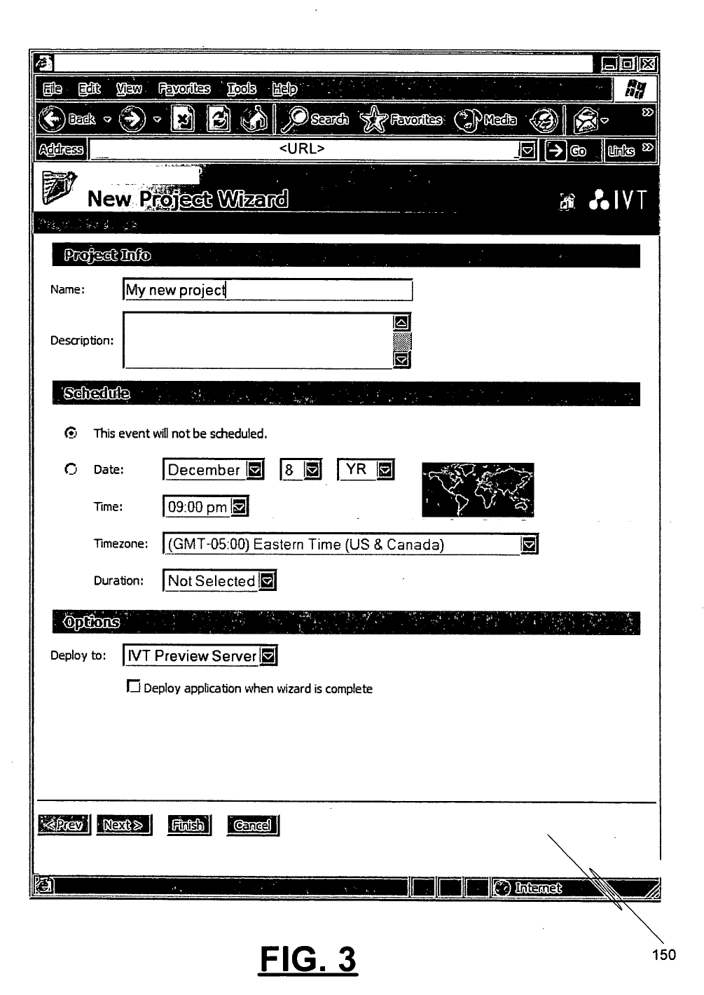

A web page builder program 102 may operate in the form of a wizard, as shown in the following operational scenario. With reference to the interface 150 of FIG. 3, an author enters preliminary information, such as a project name, when the presentation is scheduled to start, and other event data.

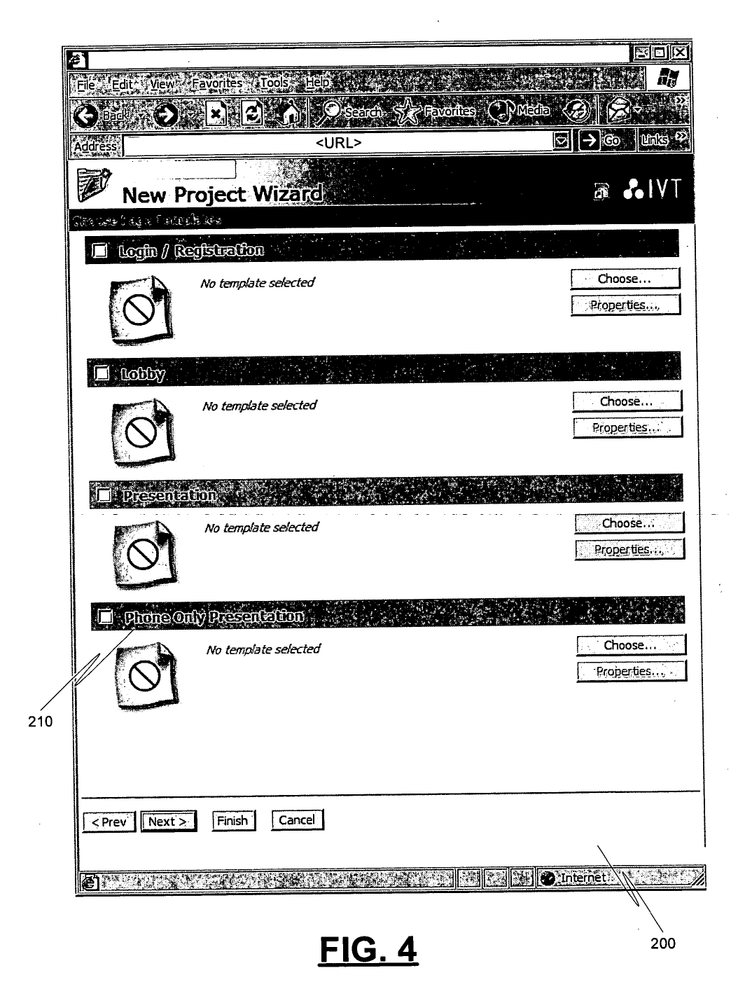

In the interface 200 of FIG. 4, an author selects one or more templates for use in the presentation project. A template may be for a phone only presentation (e.g., as shown at 210) or a video only presentation, or a presentation project may allow for both to be created.

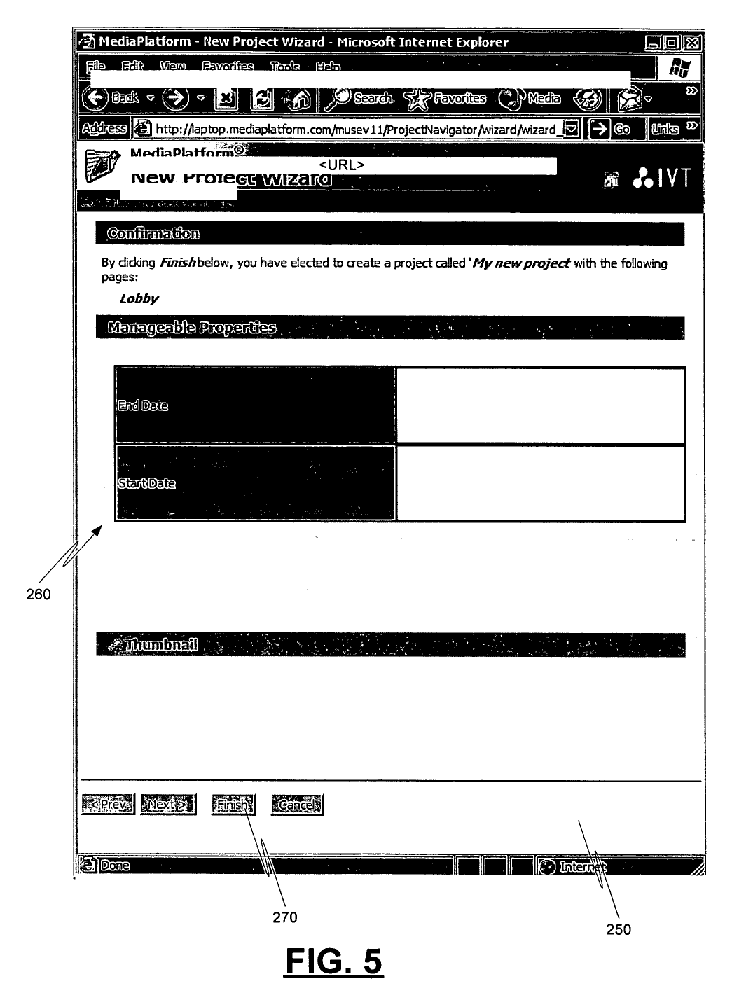

FIG. 5 illustrates an interface 250 wherein the author completes creation of a presentation project by filling in property values associated with the project (e.g., start and end dates as shown at 260, description of the event, etc.).

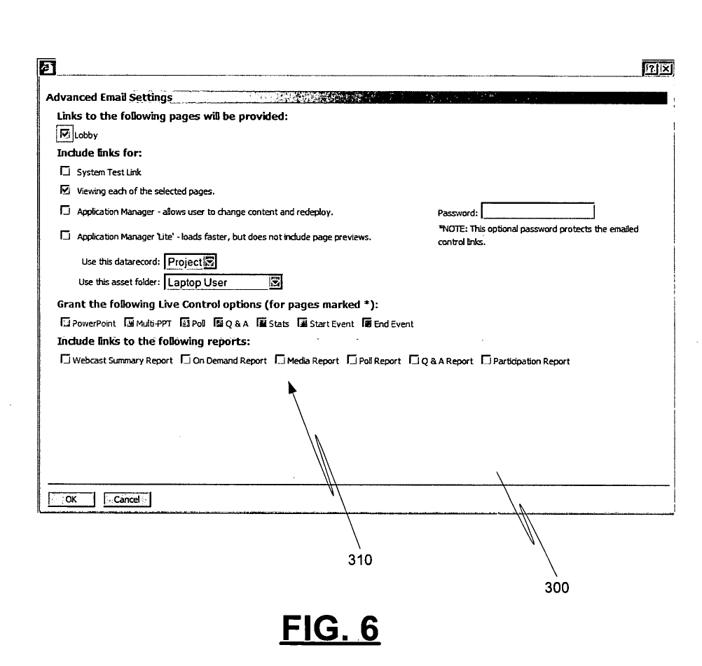

The author clicks the finish button 270 to deploy the page. One or more web pages are created with the code for accepting a stream of video and/or audio and/or for showing the slides of a presentation as a series of JPEG pictures. Optionally as shown in the interface 300 of FIG. 6, the system may e-mail various options to the end-user viewers. For example, the e-mail may allow the following live control options to be granted: PowerPoint option, multi-PowerPoint option, Poll option, Q&A option (e.g., questions can be submitted to the presenter for answering during the presentation), statistics associated with the presentation, etc. The author can configure this via options shown at 310. The author can determine which link is to be sent to an end-user viewer, such as a phone link or a video link or both.

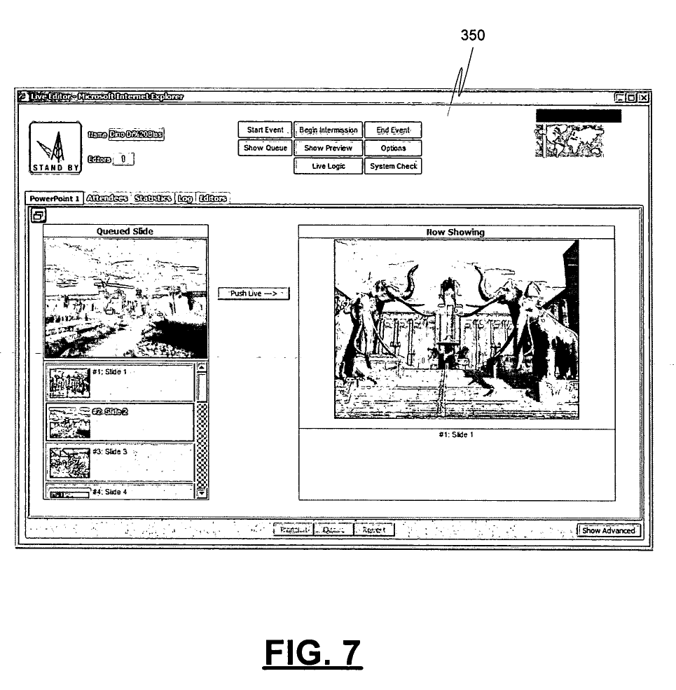

The presenter (or an assistant) uses an interface, such as the one shown in FIG. 7 for operating a live control panel 350 to run a presentation. The single live control page 350 controls both the synchronized video presentation and live (phone) presentation. Accordingly, controls manipulated by the presenter by the single interface affect both the streamed video presentation as well as any phone presentations. For example, the single interface may push an event, such as a slide flip, both to the end users listening on the phone as well as end users viewing the presentation via a video stream.

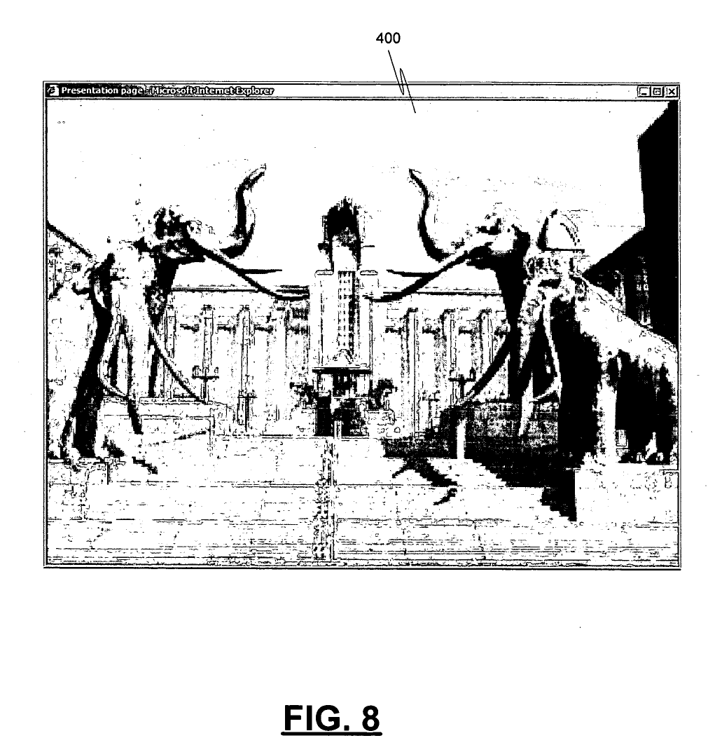

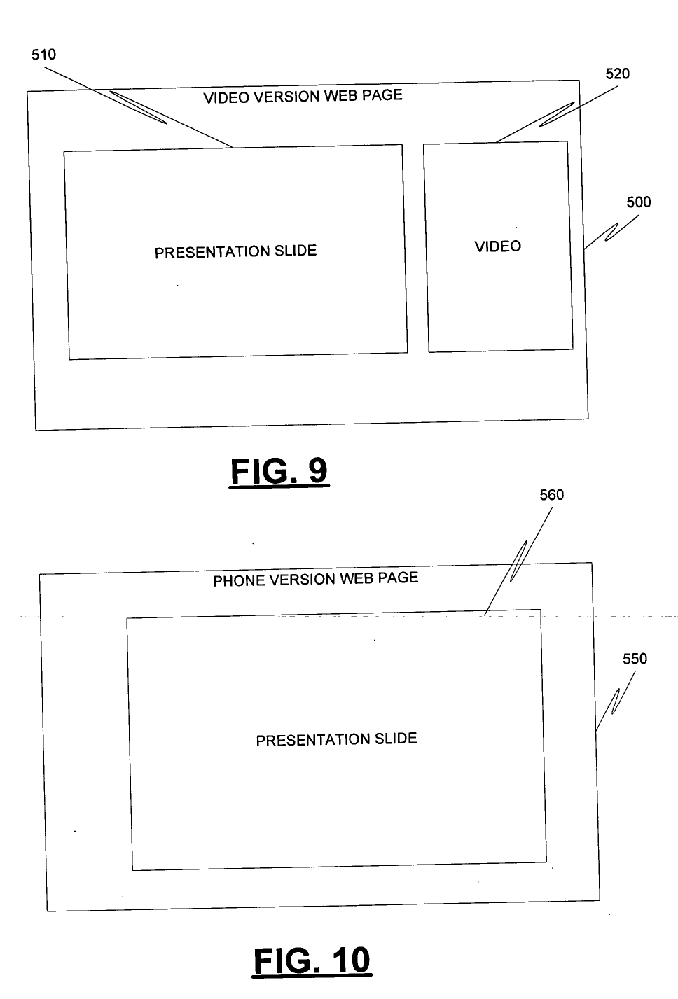

The end-users can view the presentation on a web page, such as web page 400 shown in FIG. 8. The layout and otherwise look of the presentation can be exactly the same for the user viewing the streamed presentation or the phone presentation, and the synchronization is still maintained. The presenter also has the option of making the two pages different (500 and 550) if they like as shown in FIGS. 9 and 10 or as dictated by the format specified in the deployed video web page and phone web page. For example in the interface 500 of FIG. 9, a video version web page can contain a presentation slide 510 and a separate display region 520 to contain the video. The interface 550 of FIG. 10 can be configured for a phone version web page to contain a region 560 for display of the presentation slides. Different configurations can be used in order to suit the application at hand.

In this way, customers using a single interface can run a live event that allows end users to watch a video-based web presentation, while at the same time end users can call in by phone to listen to the audio only and see the event in a browser (e.g., to see PowerPoint slides flipping, etc.) without the video.

While examples have been used to disclose the invention, including the best mode, and also to enable any person skilled in the art to make and use the invention, the invention includes other examples that occur to those skilled in the art.

It is further noted that systems and methods disclosed herein may be implemented on various types of computer networks (e.g., local area network, wide area network, or internet). Data signals may be conveyed via fiber optic medium, carrier waves, wireless networks, etc. for communication among computers. Also, the system's and method's data may be stored as one or more data structures in computer memory depending upon the application at hand. The systems and methods may be provided on many different types of computer readable media including instructions being executable by a computer to perform the system and method operations described herein.

It is further noted that the systems and methods may be implemented on various types of computer architectures, such as for example on a single general purpose computer or workstation, or on a networked system, or in a client-server configuration, or in an application service provider configuration.

In multiple computer systems, data signals may be conveyed via networks (e.g., local area network, wide area network, internet, etc.), fiber optic medium, carrier waves, wireless networks, etc. for communication among multiple computers or computing devices. Data signal(s) can carry any or all of the data disclosed herein that is provided to or from a device.

User interface screens can be web pages accessible over a network such as over the world-wide web (web). The web is a method of accessing information on the Internet which allows a user to navigate the Internet resources intuitively, without IP addresses or other technical knowledge. A user's computer can contain client software, known as a web “browser,” which is used to display web pages as well as traditional non-web files on the client system.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context clearly dictates otherwise; the phrase “exclusive or” may be used to indicate situation where only the disjunctive meaning may apply.

1. A computer-implemented method for controlling events related to presentations delivered over one or more networks, said method comprising:
generating video of a presentation;
using a conference phone call to provide audio content for the presentation;
using a presentation program to push events as the presenter is speaking;
wherein the events are synchronized to the video of the presentation;
wherein when synched in real time, the events are sent from servers directly to end viewers in real time;
wherein the end viewers listen to the presentation on the conference phone call and view the presentation through a web browser at about the same time;
wherein the web page is updated in about real time as events happen, thereby establishing synchronization to the conference phone communication.

2. The method of claim 1, wherein the presentation program is used to push presentation slide changes as events as the presenter is speaking;

3. The method of claim 1, wherein the presentation program includes a single live control page that is configured to control both synchronized video presentation and live phone presentation.

4. The method of claim 3, wherein controls manipulated by a presenter by the single interface affect both the streamed video presentation as well as any phone presentations.

5. The method of claim 4, wherein the single interface pushes a presentation event both to the end users listening on the phone as well as end users viewing the presentation via a video stream that contains the video.

6. A data signal that is transmitted using a network, wherein the data signal includes the video of the presentation and the synchronized video of claim 1; wherein the data signal comprises packetized data that is transmitted through the network.

7. Computer-readable medium capable of causing a computing device to perform the method of claim 1.

8. The method of claim 1, wherein the presentation program includes a single live control page that is configured to control both synchronized video presentation and live phone presentation;
wherein simultaneous control of presentation video events and phone events occur using the single interface.

9. The method of claim 8, wherein the web page is updated in about real time as events happen, thereby allowing simultaneous control of presentation video events and phone events to occur.

10. The method of claim 8, wherein the single interface provides control of events for a presentation that is about simultaneously being delivered both to users watching a video-based web presentation and to users calling in by phone to listen to audio only and viewing a presentation event in a web browser.

11. The method of claim 1, wherein a wizard program is used to create web pages for use by end users in order to access presentation phone and video content.
